(19) United States
(12) Patent Application Publication
(10) Pub. No.: US 2026/0086918 A1
(43) Pub. Date: Mar. 26, 2026

(54) EXECUTION-TIME TELEMETRY FOR TEAMS GROUP COPILOT EVALUATION FRAMEWORK

(71) Applicant: MICROSOFT TECHNOLOGY LICENSING, LLC, Redmond, WA (US)

(72) Inventors: Madhu SUDAN, Seattle, WA (US); Siunie Aquawati SUTJAHJO, Seattle, WA (US); Pritesh Rajesh KANANI, Kirkland, WA (US)

(21) Appl. No.: 18/893,500

(22) Filed: Sep. 23, 2024

(51) Int. Cl. G06F 11/36

(52) U.S. Cl. CPC G06F 11/3612

(57) ABSTRACT

The execution-time reporting of telemetry of execution of a software program includes identifying a software program and accessing an event stream with multiple event entries associated with the software's components. An object model is generated that comprises a hierarchy of objects and properties associated with the events by creating objects for the software's components, including identifiers, properties, and timestamps. When an AI entity is instantiated for use during the software's execution, an AI object is created with an identifier and properties. The AI object is dynamically modified to reflect events associated with the AI entity during operation of the software program. The telemetry associated with the AI entity is reported according to subscriptions for the telemetry sessions.

### BACKGROUND

Computer software sometimes has errors, flaws or faults in its design, development, or operation that causes the software to produce an incorrect or unexpected result, or to behave in unintended ways. Such errors, flaws or faults will be referred to herein as “programming issues” or “issues”. Programming issues are a common concern for software developers, and a common annoyance for software users. Such programming issues include, for example, malfunctions, crashes, inoperable features, poor performance, unhandled error conditions, and so forth. Issues may be caused by the program itself, or by a piece of software or hardware used by the program, such as an operating system, processor, memory, network connection, remote service, database, peer user's software, peer user's device, third party library, and so forth.

Identifying flaws in a program during execution runtime is crucial, especially for video conferencing applications like Microsoft Teams. The dynamic nature of conferencing conditions and participation means that any disruption can significantly impact the communication and collaboration experienced during a video conferencing session.

It will be appreciated that effective runtime monitoring is particularly important for video conferencing applications and other software programs configured to operate with multiple parties, particularly when those programs are configured to operate with artificial intelligence (AI) entities, such as instances of Microsoft Copilot, that may be dynamically assigned different tasks and have varying states of participation.

Unfortunately, conventional monitoring systems are not configured to monitor the participants of a video conference meeting in the same manner that they are configured to monitor hardware and software components. Accordingly, when AI entities are utilized as participants or in other ways by video conferencing software programs, conventional monitoring systems may not be able to gather real-time telemetry regarding the AI entities in an effective manner to facilitate debugging of the issues associated with the AI entities that are being utilized.

In view of the foregoing, it will be appreciated that there is an ongoing need and desire to improve runtime monitoring systems to address dynamic conditions of software execution, particularly video conferencing software execution, and to facilitate identification and reporting on the related software and system telemetry, as well as the telemetry of AI entities being utilized by video conferencing applications.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computing system comprises a processor and a computer-readable storage medium storing computer-executable instructions that, when executed by the processor, implement a method for the computing system. The method includes identifying a software program being executed and accessing an event stream containing multiple event entries associated with the components of the software program during execution.

The method also includes the computing system generating an object model comprising a hierarchy of objects and object properties associated with the events by generating different objects for the components of the software program. These objects include object identifiers, object properties, and timestamps associated with events corresponding to the components during the software program's execution. At least one AI object is included in the object model to reflect events associated with an AI entity utilized by the software program during execution. The AI object includes an AI object identifier, and a property set of one or more properties of the AI entity.

In some instances, the system also identifies a new event from the event stream corresponding to the utilization of the AI entity during the software program's execution and dynamically modifies the AI object in response to detecting the new event in the event stream.

Some embodiments of the disclosed invention also include execution-time reporting of telemetry of execution of a software program. In such embodiments, subscribers submit subscriptions to telemetry of a software program. In some instances, the subscription is a subscription for telemetry associated with an AI entity participating in a video conferencing session.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates aspects of the configuration and operation of a computing system for reporting telemetry of a software program to appropriate subscribers, in accordance with the principles described herein;

FIG. 2 illustrates a flowchart of a computer-implemented method for augmenting an object model in response to accessing a subscription, in accordance with the principles described herein;

FIG. 3 illustrates an example structure of a subscription for execution telemetry of a software program;

FIG. 4 illustrates an initial object model each in which object model nodes are represented as points and connections between those nodes are represented as lines, and represents an example initial object model prior to augmentation;

FIG. 5 illustrates the object model of FIG. 4 after some of the nodes of the object model have been augmented, as represented by circles surrounding the corresponding point that represents the node being augmented;

FIG. 6 illustrates an example of a call object for an object model of a software program, the call object comprising an AI object corresponding to an AI entity utilized by the software program;

FIG. 7 illustrates another example of the AI object of FIG. 6, which has been modified in view of a detected change of the AI entity associated with the AI object;

FIG. 8 illustrates a flowchart of a method for facilitating the reporting of telemetry associated with an AI entity being utilized by a software program during operation of the software program;

FIG. 9 illustrates a telemetry reporter that represents an example of the telemetry reporter of FIG. 1;

FIG. 10 illustrates a flowchart of a method for reporting telemetry of execution of a software program by interpreting the augmented object model, in accordance with the principles described herein;

FIG. 11 illustrates an example of event data being received out of order of operation and sorted into actual order of operation; and

FIG. 12 illustrates an example computing system in which the principles described herein may be employed.

### DETAILED DESCRIPTION

The disclosed embodiments include methods, systems and computer-program products for facilitating the execution-time reporting of telemetry of execution of a software program, including the reporting of telemetry for AI entities being utilized with software programs.

To facilitate reporting of telemetry corresponding to an AI entity, an object model is generated for a software program, such as a video conferencing software program, which utilizes the AI entity. The object model is based on event entries identified in an event stream (e.g., a log file of log entries associated with execution of the software program). Different call objects for the object model are created for the different components of the software program, including different participants and other components utilized during execution of the software program.

Notably, in some instances, a call object is generated for an AI entity instantiated for utilization during the video conference. The AI entity may be assigned a reactive task for a video conferencing session, for example, such as responding to a specific query directed to the AI entity and/or summarizing content of a meeting. The AI entity may also be assigned proactive tasks within a meeting, such as initiating a conversation, generating content, joining the meeting as an active virtual participant and/or moderating the meeting.

During or prior to execution of the software program, an AI object is created for the AI entity based on features of the AI entity, such as roles, tasks, skills, permissions and other attributes associated with the AI entity. Events are generated for the AI object based on utilization of the AI agent during execution of the software program. These events are used to create and/or update the object model and AI object. The AI object and the object model can be continuously updated in view of new events associated with the AI entity that identify changes to the AI entity status during the execution of the software program.

A subscription for telemetry corresponding to the execution of a software program can also be used to control when and how the object model is updated. The subscriptions for telemetry are evaluated to determine what portions of the object model are relevant when generating a telemetry report subscribed for. In this manner, it is possible for a subscriber to subscribe for telemetry reports associated with the execution of the software program and for specific components of the software program, including any AI entities utilized by the software program.

The telemetry included in the telemetry reports may be used to simply monitor performance of the software program, and AI entity, but may also be used to troubleshoot or automatically resolve any issues stemming from variation of the telemetry from expected normal behavior. The object model may then be used to perform that troubleshooting or automatic resolution. This may include enabling or disabling features associated with the AI entity.

Notably, because interpretation of the object model for any given subscription is primarily in the portion of the object model specified by the scope of a telemetry subscription, the computer resources dedicated to interpretation of the object model is also roughly proportional to the number of subscriptions, and not to the overall complexity of the program. In addition, to the extent that troubleshooting or automatic problem resolution is performed, the object model can be quickly navigated since the portion of the object model that is relevant to the encountered problem, and thus a starting point for navigation of the object model is already known.

Thus, even for very complex programs, execution telemetry may be gathered and reported quickly to the subscriber, while the software program is still executing, and potentially in real-time. Furthermore, to the extent that troubleshooting or resolving of issues are initiated from monitoring the telemetry, the root cause of any problems may be identified more quickly, and problems with execution of the software program may be more short-lived.

The foregoing can be particularly beneficial when utilizing AI entities as participants in the execution of a software program, to determine whether the AI entities are functioning as intended. Typically, participants in a video conference are not monitored in the same manner that a software component would be monitored. However, the disclosed embodiments for generating and updating object models with objects associated with AI entities being utilized with a software program can be used to effectively monitor the AI entities acting as participants in a video conferencing application or any other software program.

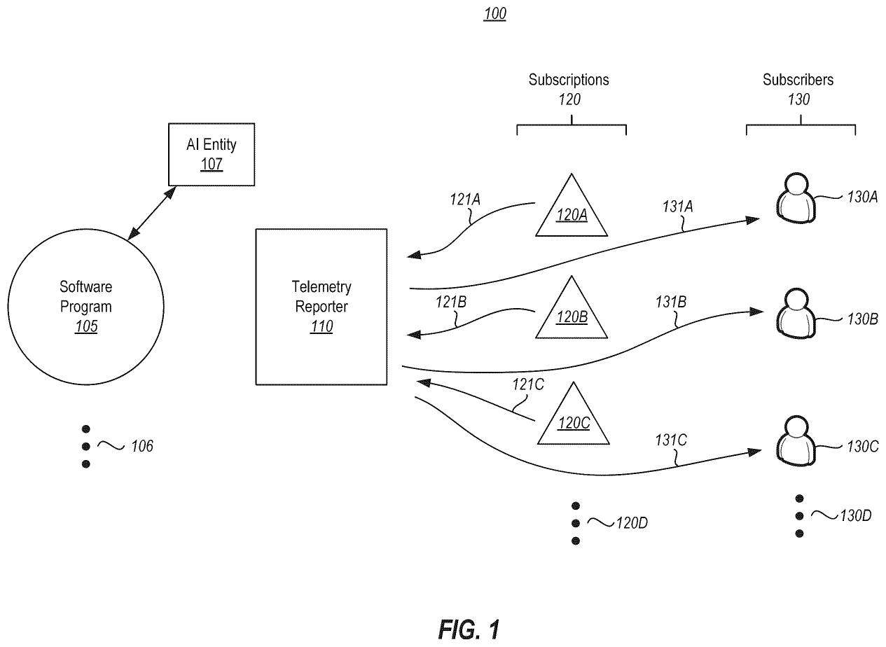

FIG. 1 illustrates aspects of the configuration and operation of a computing system 100 for reporting telemetry of a software program to appropriate entities. As shown in FIG. 1, the illustrative system 100 includes a software program 105. The software program 105 is referred to as a “software program” herein for brevity and clarity. However, the software program 105 can be any executable system, including hardware, firmware, field programmable gate array (FPGA), or the like, or a combination thereof. The software program 105 may be a distributed software program.

As an example, the software program 105 may be executed in a distributed fashion between a service in a cloud computing system with components of the software program 105 also potentially executed on one or more client computing systems. Even if the software program 105 is exceedingly complex, the principles described herein allow for timely reporting of execution telemetry of the software program 105, even whilst the software program 105 is still executing, and even potentially in real-time.

In one example, the software program 105 is a video conferencing application in which multiple users participate via their respective client computing system, and a video conferencing service interfaces with each of the client computing systems to provide the video conferencing experience.

Further, in some instances, the software program 105 is executed with the participation of and/or utilization of an AI entity 107.

As defined herein, an AI entity is a digital or virtual agent capable of performing tasks or providing services that typically require human intelligence. These entities are designed to interact with software programs, participate in processes, or engage in activities similar to a human user. They can analyze data, generate responses, make decisions, and even collaborate in real-time settings, like a video conference, where they function as an active participant. The AI entity may even be tasked with moderating a video conferencing session, for example.

Some non-limiting examples of AI entities include Large Language Models (LLMs), such as ChatGPT, which can understand and generate human-like text, making them suitable for tasks like answering questions, holding conversations, and generating content. In a software environment, LLMs can participate in a video conference by engaging in dialogue, taking notes, and providing real-time translations.

Conversational agents (Chatbots) are another form of AI entities, such as Microsoft Cortana, Google Assistant, Apple Siri, and Amazon Alexa, which can process voice commands, answer queries, control smart devices, and perform tasks based on user requests. In a video conference, a conversational agent could manage meeting schedules, set reminders, or answer specific questions related to the meeting.

Virtual assistants such as Microsoft Copilot assistants are another form of AI entities that can be configured with specialized skills and that can be integrated into enterprise software to assist with specific tasks like data analysis, customer support, or project management tasks enabled by their skills. In a collaborative software environment. They can also be tasked with real-time data analysis or providing insights to human participants during a meeting.

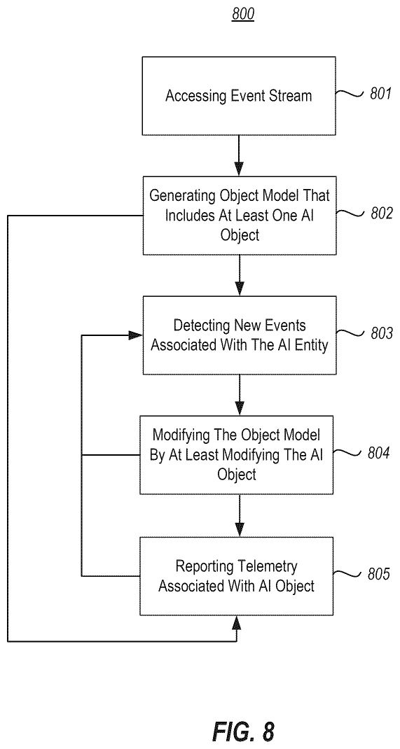

The software program 105 is associated with a telemetry reporter 110, which may operate on another server or another remote computing device as compared to the software program 105. The telemetry reporter 110 is configured to receive subscriptions to telemetry of the software program 105 and provide appropriate telemetry reports to respective subscribers. In one example, the telemetry reporter 110 is an executable component, such as the executable component 806 described below with respect to FIG. 8. As represented by the ellipsis 106, the telemetry reporter 110 may receive subscriptions and provide telemetry reports for any number (from one to many) of software programs and/or AI entities (e.g., AI entity 107) utilized by the software programs.

The telemetry reporter 110 may receive any number of subscriptions 120 to telemetry scope of execution of the software program 105. As an example, in FIG. 1, the subscriptions 120 include three subscriptions 120A, 120B and 120C. However, the ellipsis 120D represents that the telemetry reporter 110 may receive any number of subscriptions to telemetry scope of execution of the software program 105, and that the number of active subscriptions to telemetry scope of execution of the software program may increase or decrease over time. The subscription is a data structure, but in the drawings, the subscriptions will often be symbolized as being triangular.

The subscriptions 120 are each supplied by (or on behalf of) subscribers 130 who are each to receive telemetry reports of the execution telemetry of the software program, where that execution telemetry is within the telemetry scope of the respective subscription. For instance, subscriber 130A is to receive telemetry reports that include telemetry that is within the telemetry scope of the subscription 120A. Likewise, subscriber 130B is to receive telemetry reports that include telemetry that is within the telemetry scope of the subscription 120B. Also, subscriber 130C is to receive telemetry reports that include telemetry that is within the telemetry scope of the subscription 120C. Ellipsis 130D represents that there may be any number of subscribers that receive telemetry that is within the respective telemetry scope of their respective subscriptions.

A subscriber may be any entity to which a telemetry report may be sent is similarly contemplated and is within the scope of all examples disclosed herein. For example, a telemetry report may be sent to any suitable entity, such as but not limited to, an individual administrator, an artificial intelligence, a team, a corporation, an organization, or the like, or combinations of the same. Thus, the term “subscriber” is intended to be interpreted broadly as any entity that can receive and process a telemetry report.

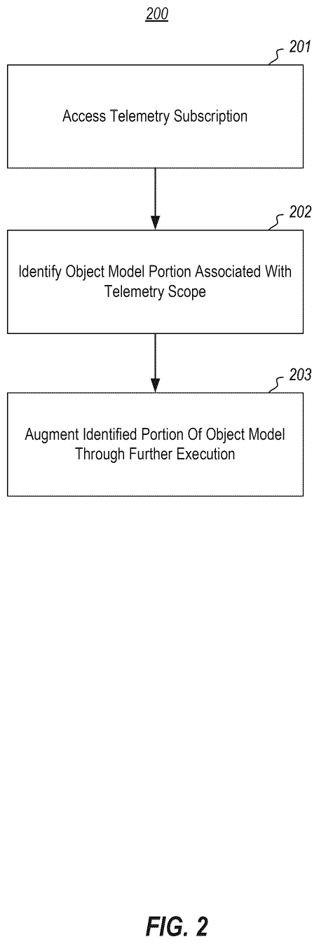

FIG. 2 illustrates a flowchart of a computer-implemented method for augmenting an object model in response to accessing a subscription. As the method 200 may be performed in the environment 100 of FIG. 1 by the telemetry reporter 110 of FIG. 1. Accordingly, the method 200 of FIG. 2 will now be described with frequent reference to the environment 100 of FIG. 1. The augmentation of the object model prepares the telemetry reporter to be able to report concerning telemetry within the scope of the respective subscriptions.

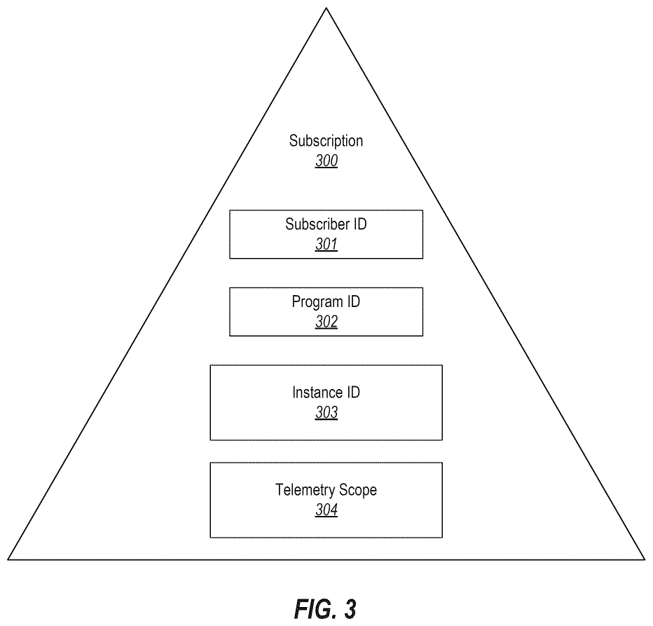

The method 200 includes accessing (act 201) a subscription to telemetry scope of execution of the software program. As an example, in FIG. 1, the telemetry reporter 110 accesses (as represented by arrow 121A) a subscription 120A. FIG. 3 illustrates an example structure of a subscription 300. The subscription 300 includes a subscriber identifier 301 that identifies an entity that is to receive telemetry reports. As an example, if the subscription 120A was the subscription 300, the subscriber identifier 301 would identify the subscriber 130A, and potentially also information that allows telemetry reports to be routed successfully to the subscriber 130A.

In the case of the telemetry reporter providing telemetry for multiple software programs, the subscription 300 may also include a program identifier 302. In the example of FIG. 1, each of the subscriptions 120 are for telemetry of the software program 105. Accordingly, if the subscription 300 was the subscription 120A of FIG. 1, the program identifier 302 would identify the software program 105. Alternatively, if the telemetry reporter 110 only serves a single software program 105, or if the software program 105 is interpreted by default as being the relevant software program absent an identifier, then the subscription 300 need not have the program identifier 302.

The subscription also includes an instance identifier 303 that identifies an execution instance of the software program. As an example, if the software program 105 is a video conferencing application, the execution identifier 303 may be a meeting identifier. Each execution instance of a software program has an associated object model that is created at the instantiation of the software program or instance of the software program (e.g., a video conferencing session).

The subscription 300 also includes a telemetry scope 304 that defines what telemetry should be reported in telemetry reports as part of the subscription 300. The telemetry scope may identify the type of telemetry as well as potentially any rules about how to construct the telemetry and potentially when the telemetry is to be reported.

In some instances, the telemetry scope includes a name or other identifier of a software or system component, a temporal identifier, such as a timestamp or a sequence number, a name or type of an event, a task or a property, or other searchable identifer or value associated with a software or system component. In some instances, the telemetry scope is an identifier of an AI entity, or an AI skill or task utilized during execution of a software program, wherein the AI entity is considered one of the software or system components.

A skill in the context of an AI entity refers to a specific capability or function that the AI can perform autonomously. It is a discrete, well-defined ability that allows the AI to carry out particular tasks or solve certain problems based on the input it receives. These skills can range from simple operations, like retrieving information, to more complex tasks, such as natural language understanding or image recognition. The AI skills can also include specific actions such as opening a whiteboard or setting up a follow-up meeting, by way of example.

In some instances, an AI entity is associated with one or more modular skills that may be enabled or disabled during operation of a software program utilizing the AI entity. The different AI entity skills are one feature of an AI entity that may be identified in the telemetry scope to be reported to a subscriber.

Some non-limiting examples of AI skills include natural language processing (NLP), which includes interpreting and generating human language, speech recognition and converting spoken language into text, object recognition, sentiment analysis, data analysis to identify trends or patterns, recommendation generation for suggesting products, content, or actions based on user behavior and preferences, information retrieval for fetching and present information from knowledge bases, and other skills that enable the AI entities to perform roles more effectively, enhancing their abilities to interact with users, manage tasks, and contribute to achieving specific goals within a software environment.

The subscription 300 for telemetry data is created, in some instances, in a response to a user (such as a subscriber) using a dashboard to create a subscription. As an example, in a video conferencing application, the subscriber might use the dashboard to enter the meeting identifier, and then also identify that metric that the subscriber is interested in. The subscriber might also identify a particular AI entity or AI entity feature (e.g., skill or property).

Referring back to the method 200, for the accessed subscription, the telemetry reporter then identifies (act 202) a portion of an object model of the software program that is applicable to the subscribed telemetry scope. When the software model is executed, the execution may create a hierarchical object model that represents a basic state of execution. For example, for a complex video conferencing software program, there may be nodes of the object model that represent the participants, the servers, the media, and other high-level aspects of the execution.

The object model may be kept simple compared to the software object model by representing only key aspects of the execution. Thus, the object model does not initially include enough information to derive the telemetry subscribed to by a subscription. As an example, suppose that the subscriber wants to know the average video jitter experienced by all participants (human and AI) of a given server. The object model may have a node representing video of that given server but may not initially have sufficient detail to determine performance of the video channels from that given server to the various participants connected via that given server.

However, when the subscription is accessed (act 201) and the associated telemetry scope is compared against the object model, the appropriate part of the object model that should be augmented is then identified (act 202). In the example in which a subscriber wants to know the average video jitter experienced by all participants of a given server, that object model portion to be augmented may include the video node for the participant nodes that correspond to the server of interest, as well as potentially the node that represents the server itself, which may be updated with an aggregation of the telemetry augmented into the participant-specific nodes.

Additionally, in some instances, a user may want to know when an AI entity performs certain tasks, such as summarizing content into a translated language. In such an instance, the object model portion to be augmented may include the AI object node for the AI entity, which may be updated or augmented with telemetry associated with the AI summarization and translation events.

In some instances, the system may also independently augment the AI object node with such telemetry independent of receiving a subscribed request for that telemetry data. This may be beneficial when anticipating a request for such telemetry data, such as by monitoring events that are logged during operation of a software program utilizing the AI object.

In some instances, the augmentation of the object model includes the creation of a new AI call object and/or modification of an existing AI call object corresponding to a configuration of the AI entity that is being utilized by the software program at different instances, such as when an AI entity is assigned a specific task to complete (e.g., answer a chat query), or when the AI assistant is assigned as an active participant in a meeting, such as by being tasked with being a moderator of a meeting, or when the AI entity is utilized to summarize or generate content for a meeting and/or to perform another task that the AI entity is configured to perform during execution of the software program.

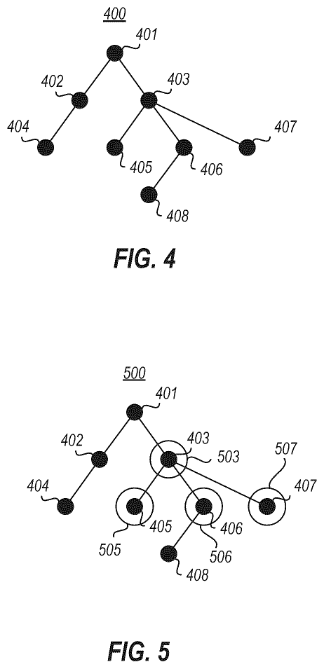

FIG. 4 illustrates an initial object model 400 that is kept relatively simple for illustrative purposes. The nodes in the object model 400 are represented as mere dots to represent that the amount of data kept for any given node of the object model may be quite minimal - just enough perhaps to keep execution of the software program proceeding. Since each node may be a minimal representation, even if there are many nodes in the object model (as would be the case for a complex object model), the object model may still be represented and updated without overwhelming computing capacities. Furthermore, the object model 400 may be kept in a distributed fashion. As an example, each server that supports an application might keep that portion of the object model that relates to that server.

Though there may be many nodes in an object model, for illustrative purposes, the object model 400 is shown as having merely eight nodes 401 through 408. In one example referred to herein as the “subject example”, the interpretation of the subscription 120A causes the telemetry reporter 200 to determine that it is the nodes 403, 405, 406 and 407 that should be augmented as execution of the software program proceeds.

Returning to the method 200, the telemetry reporter then augments (act 203) the portion of the object model through execution of the software program, such that the augmented structure is built upon the object model. As an example, FIG. 5 illustrates an object model 500 that is the same as the object model 400 of FIG. 4, except that there are circles around the nodes 403, 405, 406 and 407 that represents that in the subject example these nodes were augmented with telemetry information as execution of the software program proceeds. The additional structure associated with nodes 403, 405, 406 and 407 are represented by circles 503, 505, 506 and 507. Augmentation of a node of the object model may occur by extending the object model from that node creating new nodes, and/or by augmenting the data associated with the identified node.

As noted earlier, the execution of a software program initiates the generation of an object model that can be used for generating telemetry reports corresponding to the software program during operation of the software program. As an example, if the software program 105 is a video conferencing application, the execution identifier 303 may be a meeting identifier. Each execution instance of the software program will have an associated object model that is created beginning at the initiation of the execution of the software program and that will include call objects for the different components of the software program being utilized during the operation of the software program. This may, according to the present disclosure, include call objects for AI entities that are utilized during the operation of the software program.

Up to this point, the specific structure of the object model has not been described in detail. This is because the principles described herein are not limited to any particular software program, nor to any manner of constructing an object model from a software program and its execution, nor to the specific design or structure of an object model. However, in one example, the software program is a distributed video conferencing application. In that case, the object may be hierarchically structured with different nodes representing a server (e.g., a virtual machine), a channel (e.g., a video, audio, or data channel) or a participant.

In one embodiment only, the top node in the object model represents a meeting, and thus each meeting in a virtual conferencing application has an associated object model. In the example, the next level is a server (or virtual machine) level. A next level could be a participant level, where a participant node is a child node of the server node that the participant is connected to. This may include a node for an AI entity utilized by the software program, for example. The next level could be a channel level in which each node represents a channel (e.g., video, audio, data, control) between the respective participant (human and/or AI entity) and the respective server. Each of the nodes may include data associated with that node.

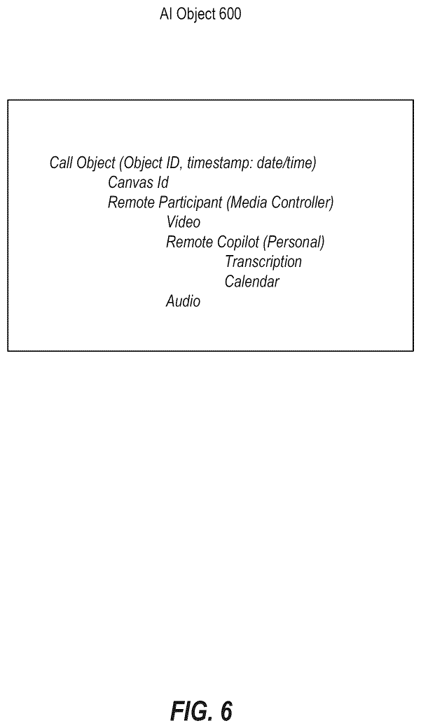

The illustration in FIG. 6 is provided as a non-limiting example of a call object corresponding to an AI entity that may be utilized by a software program such as a video conferencing application and that may be represented as one of the nodes shown in the object models referenced in FIGS. 4 and 5.

As shown, the present AI object 600 includes various properties, including a name and time associated with the AI entity being utilized by the software program. These properties may be extracted from events (e.g., event logs) included in an event stream corresponding to operations of the computing system when executing the software program. These events are directed to or intercepted by the telemetry reporter 110, for example, and used to generate and/or update the object model that includes one or more of the call objects described herein. The AI object 600 is a non-limiting representation of a call object that can be created for an AI entity and may include different information presented hierarchically based on actions taken by the AI entity, interactions of the AI entity, skills enabled by the AI entity, and other components or entities interacting the with AI entity during execution of the software program.

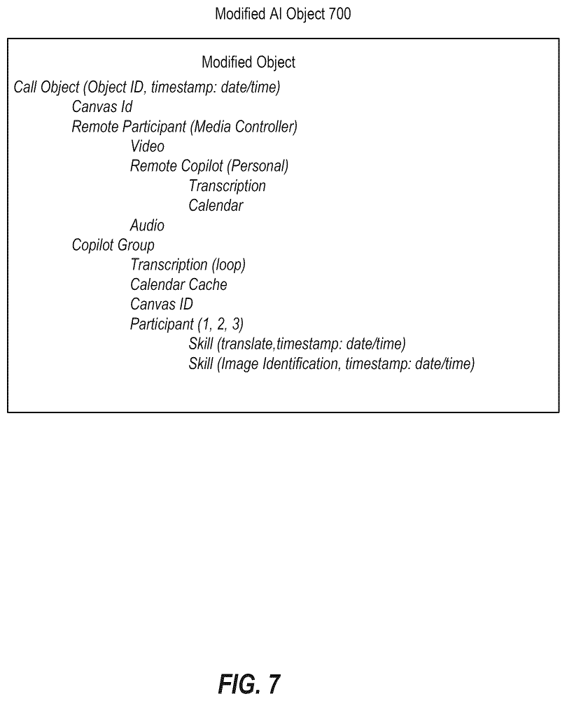

FIG. 7 illustrates another example of the AI object shown in FIG. 6. In this illustration, the AI object has been modified to include additional properties that were not initially present in the original AI object that was created during, subsequent to, and/or in response to the software program being instantiated. In this example, the AI object is modified subsequent to initiation of a video conferencing session that utilizes the AI entity.

As shown, the AI object has been modified to include additional properties and information associated with AI entity, including, among other things, new skills that have been enabled or utilized by the AI entity (e.g., translate and image identification). The addition of this supplemental information for the new skills can result from the telemetry reporter detecting events in the event stream that reflect that the AI entity invoked those new skills. Alternatively, or additionally, the new skills can be added to the AI object in response to detecting a subscription scope that includes those new skills (when invoked), such as when an entity subscribes to know when those skills are invoked. Then, the telemetry reporter can evaluate the object model for any telemetry included in the objects of the object model that include the telemetry subscribed for and report on that telemetry.

Now, suppose a subscriber wants to see performance metrics or other telemetry associated with the AI entity being utilized by the software program. In such an instance, the subscriber can subscribe for telemetry data associated with the AI entity and the subscription can be used to identify telemetry data from the object model of the software program that includes the AI object. The subscriber may specify the telemetry scope by including the name of the AI entity and/or a feature of the AI entity, for example, in a request for telemetry data sent to the telemetry reporter.

In such a circumstance, the AI object node of the object model may be augmented with data representing the specific features of the AI entity that the subscriber is interested in evaluating, if such telemetry is not already included in the AI object. The telemetry reporter may then monitor the augmented data in that AI object node and apply rules associated with the telemetry scope to verify whether the data included in the object model should be reported to the subscriber.

Now, in a second example, suppose in one that a subscriber wants to see video statistics for participant A. In this case, there is just one node of the object model that is to be augmented. That would be the video channel node that is a child node of the participant node that identifies the associated participant. That node may be augmented with data representing video performance measurements. The telemetry reporter may then monitor the augmented data in that node and apply rules associated with the telemetry scope to verify whether the data should be reported to the subscriber.

In a third example, aggregation of data across multiple nodes is performed. For instance, the subscriber may want a count, average, and/or maximum of the number of participants using a server. In this case, the node that is to be augmented is the node that represents the server. That node is then augmented with data over time of the number of participant nodes that are child nodes of that server node. An aggregator can then use that data over time to aggregate the data and send that aggregated data in the report to the subscriber.

Subscriptions can even cause actions to occur in order to generate the data of interest. As an example, a subscription might cause a speed test to be performed periodically to monitor the bitrate speed over a particular connection over time. Thus, the subscriptions may cause the telemetry reporter to affirmatively perform actions in addition to augmenting and interpreting the object model.

Accordingly, the principles described herein allow for prompt reporting of execution telemetry of even complex software programs while the software program is still executing, and potentially in real-time.

Attention is now directed to FIG. 8, which illustrates a flowchart of a method for facilitating the reporting of telemetry associated with an AI entity being utilized by a software program during operation of the software program. This method may be implemented by the telemetry reporter or other system components described herein.

As shown, the first illustrated act of the method includes accessing an event stream (act 801), such as the event logs of a log report created during execution of a software program and that identify different operations of the computing system during execution of the software program.

The method also includes generating an object model based on the events in the event stream and that includes at least one AI object (act 802). The object can take different forms but includes at least an identifier for the AI entity and at least a timestamp in which the AI entity is utilized, along with at least one other property associated with the AI entity. Such a property can include audio, video or other data accessed by or generated by the AI entity, at least one other component (e.g., a calendar application or knowledge base) or entity interacting with the AI entity (e.g., a video participant participating in the video session), a skill invoked by the AI entity (e.g., translation, image identification).

The method also includes detecting new events associated with the AI entity (act 803) and modifying the corresponding AI object (act 804) for facilitating reporting of telemetry associated with the AI object (act 805) by the telemetry reporter based on any subscriptions for the telemetry, as described herein.

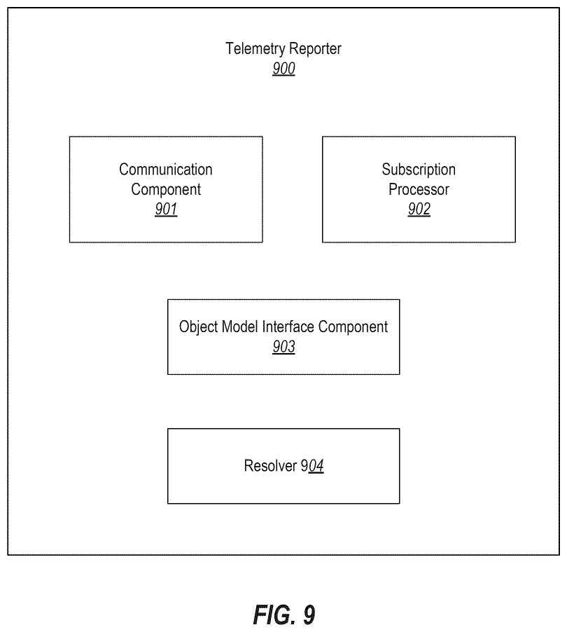

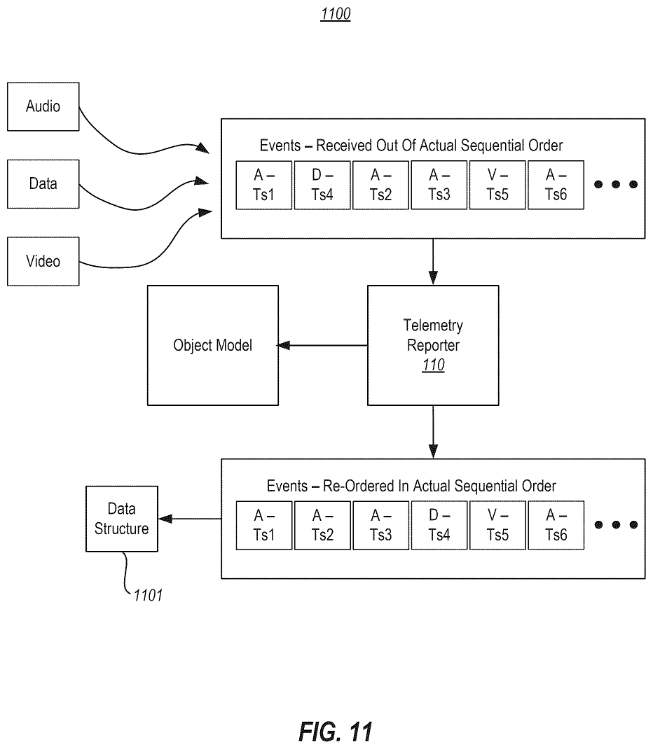

FIG. 9 illustrates a telemetry reporter 900 that represents an example of the telemetry reporter 110 of FIG. 1. The telemetry reporter 900 includes a communication component 901 that is configured to receive the various subscriptions (e.g., act 201), and a subscription processing component 902 that is configured to identify which object model and which portion of the object model should be augmented (e.g., act 202). An object model interface component interfaces with the object model to cause the identified portion of the object model to be augmented with further execution of the associated software program (e.g., act 203). The telemetry reporter 900 also includes a resolver component 904 that automatically resolves any problems reflected in variation of reported telemetry from expected behavior by interacting with the object model at or around the portion that was evaluated to generate the telemetry, and by potentially also interacting with the subscriber. Each of the components 901, 902, 903 and 904 may be structured as described below for the executable component 906 of FIG. 11.

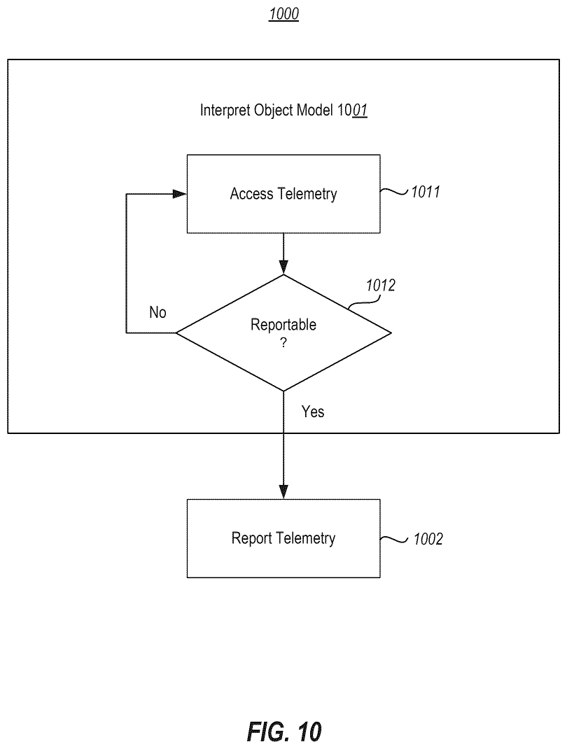

Up to this point, the creation and augmentation or modification of the object model has been described. From this point, the use of the augmented object model to report respective telemetry to subscribers will now be described. FIG. 10 illustrates a flowchart of a method 1000 for reporting telemetry of execution of a software program by interpreting the augmented object model, in accordance with the principles described herein. The method 1000 may be performed by the telemetry reporter 110 of FIG. 1. As a more specific example, the method 1000 may be performed by the telemetry reporter 1000 in FIG. 9.

The telemetry reporter interprets the augmented object model (act 1001). This allows the telemetry reporter to determine the telemetry within the telemetry scope of the subscription (act 1011), and to determine whether the telemetry is to be reported in accordance with the subscription (decision block 1012). If there is no telemetry to be reported (“No” in decision block 1012), then the object model just continues to be augmented and/or updated with new telemetry information. However, if there is telemetry to be reported (“Yes” in decision block 712), then the telemetry reported causes the determined telemetry to be reported in accordance with the subscription (act 1003).

The method 1000 may be performed multiple times even for a single subscription to thereby send multiple telemetry reports to the subscriber. Thus, the subscriber may receive different sequential values of the determined telemetry. The method 1000 may even be continuously performed so that the telemetry reports are streamed to allow the subscriber to see continuously changing values of the telemetry to which the subscriber has subscribed.

Furthermore, method 1000 may be performed multiple times for each of multiple subscriptions 300. As an example, in FIG. 1, the method 1000 may be performed to access (as represented by arrow 121A) the subscription 120A and cause the appropriate portions of the object model to be augmented and to report (as represented by arrow 131A) respective telemetry report(s) to the subscriber 130A.

Attention is now directed to FIG. 11, which illustrates how the telemetry reporter may receive events corresponding to execution of a software program in an ordering that does not reflect an actual order of operation. This incorrect ordering may result from latency in some event data being processed due to audio, video and AI entity interactivity with end users during execution of the software program. For instance, a task assigned to an AI entity may be completed and reported to the telemetry reporter prior to an audio stream being completed by a user which triggered the task, as the user may still be speaking when the task is completed and the audio event associated with the user's speech may not be reported until the user stops speaking. By way of another example, the AI entity may interact with a remote third-party entity to perform a task. But the interactions with the third-party entity may not be reported until much later in a video session than other events that take place.

In any event, the telemetry reporter can correctly log the timing of the different events in the object model hierarchy and can also update a separate sequential data record of events that is created and/or updated to reflect the correct sequence of events, even when the events are received and reported to the telemetry reporter out of actual order of operation.

This is shown in FIG. 11, as audio, video and other data events received from the different audio, video and data channels of a software program are received by the telemetry reporter 110 during execution of the software program. Notably, these events may be received out of the actual order of operation. The telemetry reporter can resolve this inconsistency in ordering by creating a new re-ordered sequence of events that matches the actual order of operation and that is saved as a separate data structure 1101 for subsequent reference. This separate data structure 1101 can also be updated as new events are received from a same source (E.g., the log report of a video conferencing software application being executed) and/or from other components in communication with the telemetry reporter (E.g., a log report from a different software application being executed concurrently with the video conferencing software application). In particular, the telemetry reporter can interleave the different events based on their actual order of operation within the data structure 1101, even though the events were detected or received out of actual order of operation.

The telemetry reporter can order the events based on event operation timestamps received with the events. The timestamps may be explicitly identified with each event in the event stream. Alternatively, some events may be received without explicit timestamps and the telemetry reporter may infer the timestamp based on sequence of operation logic when the events do not include actual event operation timestamps.

The telemetry reporter may identify the timestamps of the different events in the object model, with different timestamps being reflected for different events that are identified in the object model, and which may be queried subsequently to identify telemetry corresponding to a subscribed telemetry scope, as previously described herein.

In view of the foregoing, it will be appreciated that the disclosed embodiments may be used to facilitate a system reporting on telemetry of a software program being executed, as well as on the AI entities and other components being utilized by the software program during execution. In such embodiments, a system may be configured to access an event stream, the event stream containing a plurality of event entries associated with components of a software program during execution of the software program, generate an object model comprising a hierarchy of objects and object properties associated with the plurality of events, and report on telemetry from the object model.

The system may generate the object model, as described, by generating objects for the components of the software program, the objects including object identifiers, object properties and timestamps associated with events corresponding to the components during execution of the software program. This also includes creating an AI object for the object model, the AI object including an AI object identifier and a property set of one or more properties of an artificial intelligent (AI) entity instantiated for utilization during execution of the software program. This also includes identifying a new event from the event stream corresponding to the utilization of the AI entity during the execution of the software program and dynamically modifying the AI object in response to detecting the new event.

Notably, the new event may identify a task performed by the AI entity, such that the AI object is dynamically modified to reflect the task performed by the AI entity.

The new event may also identify a feature (e.g., a skill) enabled or disabled for the AI entity and wherein the AI object is dynamically modified to reflect the feature that is enabled or disabled for the AI entity.

The new event may also identify a change in a status of the AI entity (e.g., assigned moderator role or a more passive listener and note-taker role for summarizing a meeting) and wherein the AI object is dynamically modified to reflect the change in the status of the AI entity. In some instances, the change in status reflects a node or path in a decision tree pursued by the AI entity that is associated with different skills or tasks for the AI entity. In other instances the change in status reflects the metrics or a state of performance or utilization of the AI entity or of tools utilized by the AI entity.

The new event may also identify the AI entity as a participant in a session of the software program being executed and wherein the AI object is dynamically modified to reflect the status of the AI entity as a participant (e.g., when the AI entity joins or leaves the meeting)

In some instances, the method further comprises dynamically modifying the AI object in response to a subscription request for telemetry corresponding to the new event. For instance, when a subscriber requests telemetry corresponding to the AI entity performing a particular skill, the object model of a software program instance can be updated to reflect a modified AI object with information specifying the activity of the AI entity when the AI entity uses the skill during execution of the software program.

As also disclosed, some methods of the invention also include updating a timeline data structure with event data from the identified events to correlate the events from the event stream that are received out of an actual order of operation due to a latency in transmission of some of the event data to reflect a modified and actual sequential ordering that matches the actual order of operation of the identified events.

During reporting of the telemetry data, the system may access a subscription to telemetry scope of execution of the software program, identify telemetry from a portion of the AI object of the object model that is applicable to the subscribed telemetry scope and, in response to determining that the telemetry is to be reported in accordance with the subscription, cause the determined telemetry to be reported in accordance with the subscription as a telemetry report transmitted to the subscriber.

This telemetry scope may be associated with a skill associated with the AI entity, a video channel of the video conferencing application, an audio channel of the video conferencing application and/or a data channel of the video conferencing application. In some embodiments, the telemetry scope is focused to a scope that includes utilization and/or performance of at least one of the following: screen sharing, 3D communications, video channels, audio channels, other media channels, AI modules, and/or other and or other applications or tools used with a video conferencing application.

When the software program utilizes multiple AI entities during execution of the software application, the system will create a different AI object for each different AI entity invoked during execution of the software program. Each of the different AI objects will having a different AI object identifier and a different property set of one or properties of the different AI entity that are distinguished from the set of one or more properties of the other AI entities being utilized. The object model will also be updated, during execution of the software program, to include the different AI objects that are created and modified.

The principles described herein are performed in the context of a computing system which executes a software program. Accordingly, some introductory discussion of a computing system will be described.

Computing systems are now increasingly taking on a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

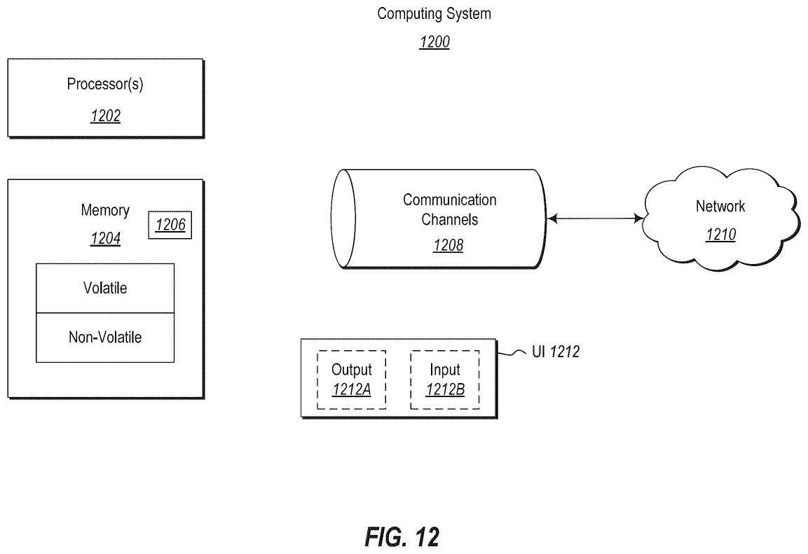

As illustrated in FIG. 12, in its most basic configuration, a computing system 1200 includes at least one hardware processing unit 1202 and memory 1204. The processing unit 11202 includes a general-purpose processor. Although not required, the processing unit 1202 may also include a field programmable gate array (FPGA), an application specific integrated circuit (ASIC), or any other specialized circuit. In one embodiment, the memory 1204 includes a physical system memory. That physical system memory may be volatile, non-volatile, or some combination of the two. In a second embodiment, the memory is non-volatile mass storage such as physical storage media. If the computing system is distributed, the processing, memory and/or storage capability may be distributed as well.

The computing system 1200 also has thereon multiple structures often referred to as an “executable component”. For instance, the memory 1204 of the computing system 1200 is illustrated as including executable component 1206. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods (and so forth) that may be executed on the computing system. Such an executable component exists in the heap of a computing system, in computer-readable storage media, or a combination.

One of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 1204 of the computing system 1200. Computing system 1200 may also contain communication channels 1108 that allow the computing system 1200 to communicate with other computing systems over, for example, network 1210.

While not all computing systems require a user interface, in some embodiments, the computing system 1200 includes a user interface system 1212 for use in interfacing with a user. The user interface system 1212 may include output mechanisms 1212A as well as input mechanisms 1212B. The principles described herein are not limited to the precise output mechanisms 1212A or input mechanisms 1212B as such will depend on the nature of the device. However, output mechanisms 1212A might include, for instance, speakers, displays, tactile output, virtual or augmented reality, holograms and so forth. Examples of input mechanisms 1212B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then be eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A computing system, comprising:
a processor;
a computer-readable storage medium in communication with the processor, the computer-readable storage medium having computer-executable instructions stored thereupon which are executable by the processor for causing the processor to implement a method that includes the computing system:
accessing an event stream, the event stream containing a plurality of event entries associated with components of a software program during execution of the software program;
generating an object model comprising a hierarchy of objects and object properties associated with the plurality of events by at least:
generating objects for the components of the software program, the objects including object identifiers, object properties and timestamps associated with events corresponding to the components during execution of the software program;
creating an AI object for the object model, the AI object including an AI object identifier and a property set of one or more properties of an artificial intelligent (AI) entity instantiated for utilization during execution of the software program;
identifying a new event from the event stream corresponding to the utilization of the AI entity during the execution of the software program; and
dynamically modifying the AI object in response to detecting the new event.

2. The computing system of claim 1, wherein the new event identifies a task performed by the AI entity and wherein the AI object is dynamically modified to reflect the task performed by the AI entity

3. The computing system of claim 1, wherein the new event identifies a feature enabled or disabled for the AI entity and wherein the AI object is dynamically modified to reflect the feature that is enabled or disabled for the AI entity.

4. The computing system of claim 1, wherein the new event identifies a change in a status of the AI entity and wherein the AI object is dynamically modified to reflect the change in the status of the AI entity.

5. The computing system of claim 4, wherein the new event identifies the AI entity as a participant in a session of the software program being executed and wherein the AI object is dynamically modified to reflect the status of the AI entity as a participant.

6. The computing system of claim 1, wherein the method further comprises: dynamically modifying the AI object in response to a subscription request for telemetry corresponding to the new event.

7. The computing system of claim 1, wherein the method further comprises: updating a timeline data structure with event data from the identified events to correlate the events from the event stream that are received out of an actual sequential order of operation due to a latency in transmission of some of the event data to reflect a modified and actual sequential ordering that matches the actual order of operation of the identified events.

8. The computing system of claim 1, wherein the method further comprises:
accessing a subscription to telemetry scope of execution of the software program;
identifying telemetry from a portion of the AI object of the object model that is applicable to the subscribed telemetry scope; and
in response to determining that the telemetry is to be reported in accordance with the subscription, causing the determined telemetry to be reported in accordance with the subscription.

9. The computing system of claim 8, the subscription to telemetry scope being associated with a skill associated with the AI entity.

10. The computing system of claim 9, the subscription to telemetry scope further being associated with a video channel of the video conferencing application.

11. The computing system of claim 9, the subscription to telemetry scope further being associated with an audio channel of the video conferencing application.

12. The computing system of claim 9, the subscription to telemetry scope further being associated with a data channel of the video conferencing application.

13. The computing system of claim 1, wherein the method further comprises:
creating a different AI object for a different AI entity invoked during execution of the software program, the different AI object having a different AI object identifier and a different property set of one or properties of the different AI entity that are distinguished from the set of one or more properties of the AI entity; and
modifying the object model to include the different AI object.

14. The computing system of claim 1, wherein the software program comprises a video conferencing application and wherein execution of the video conferencing application includes instantiating a video conferencing session with at least one human participant and wherein the AI entity comprises another participant in the video conferencing session.

15. The computing system of claim 1, wherein the event stream comprises a log file of log entries associated with operations of the software program during execution of the software program.

16. A computer-implemented method for facilitating the reporting of telemetry for AI entities utilized by software programs, the method including:
accessing an event stream, the event stream containing a plurality of event entries associated with components of a software program during execution of the software program;
generating an object model comprising a hierarchy of objects and object properties associated with the plurality of events by at least:
generating objects for the components of the software program, the objects including object identifiers, object properties and timestamps associated with events corresponding to the components during execution of the software program;
identifying a new event from the event stream corresponding to the utilization of the AI entity during the execution of the software program; and
dynamically modifying the AI object model in response to detecting the new event and by at least creating an AI object for the object model, the AI object including an AI object identifier and a property set of one or more properties of AI entity being utilized during execution of the software program.

17. The method of claim 16, wherein the new event identifies a task performed by the AI entity and wherein the AI object is dynamically modified to reflect the task performed by the AI entity.

18. The method of claim 16, wherein the method further comprises: updating a timeline data structure with event data from the identified events to correlate the events from the event stream that are received out of an actual sequential ordering of event occurrence due to a latency in transmission of some of the event data to reflect a modified and actual sequential ordering that matches the actual sequential ordering of event occurrence.

19. The method of claim 16, wherein the method further comprises:
accessing a subscription to telemetry scope of execution of the software program;
identifying telemetry from a portion of the AI object of the object model that is applicable to the subscribed telemetry scope; and
in response to determining that the telemetry is to be reported in accordance with the subscription, causing the determined telemetry to be reported in accordance with the subscription.

20. The method of claim 1, wherein the software program comprises a video conferencing application and wherein execution of the video conferencing application includes instantiating a video conferencing session with at least one human participant and wherein the AI entity comprises another participant in the video conferencing session.
